(19) United States
(12) Patent Application Publication
(10) Pub. No.: US 2026/0070815 A1
(43) Pub. Date: Mar. 12, 2026

(54) PHOTOOXIDATION OF PFAS AT 222 nm

(71) Applicant: Claros Technologies Inc., Minneapolis, MN (US)

(72) Inventors: Zekun Liu, Brooklyn Park, MN (US); Evan Anthony Leslie, Minneapolis, MN (US); Joseph Reuel Levine Tirado, Minneapolis, MN (US); Cheng-Hsin Huang, Saint Paul, MN (US); Terrance P. Smith, Woodbury, MN (US)

(73) Assignee: Claros Technologies Inc., Minneapolis, MN (US)

(21) Appl. No.: 19/325,288

(22) Filed: Sep. 10, 2025

Related U.S. Application Data
(60) Provisional application No. 63/693,633, filed on Sep. 11, 2024.

(51) Int. Cl. C02F 1/32; C02F 1/68; C02F 1/72; C02F 101/36; C02F 103/34

(52) U.S. Cl. CPC C02F 1/325; C02F 1/68; C02F 1/72; C02F 2101/36; C02F 2103/346; C02F 2201/32; C02F 2209/06; C02F 2305/02

(57) ABSTRACT

Methods and systems for treating wastewater for PFAS reduction including mixing wastewater including PFAS with an oxidizing species to form a treatment solution and exposing the treatment solution to UV light from a UV light source at 222 nm for an adequate time and at a sufficient intensity to destroy the PFAS. The oxidizing species may be a persulfate ion. The wastewater may include a polymeric PFAS, a perfluoroalkyl carboxylate, a partially fluorinated perfluoroalkyl carboxylate, a perfluoroalkyl alkoxide or a perfluoroalkyl alcohol, for example. The wastewater may be wastewater produced during semiconductor manufacturing.

### RELATED APPLICATIONS

This application claims priority to U.S. Provisional application No. 63/693,633, entitled TREATMENT OF PFAS CONTAMINATED BY PHOTOREDUCTION, filed Sep. 11, 2024, the disclosure of which is hereby incorporated by reference in the entirety.

### BACKGROUND OF THE INVENTION

Per- and polyfluoroalkyl substances (PFASs) are a class of synthetically prepared compounds that have been used for decades in numerous consumer and industrial applications. PFASs have some unique surface properties and can also be both hydrophobic and oleophobic. As a result, PFASs are used as coating aids, lubricants, foaming aids and various surface treatments. They have proven especially useful as flame retardants in the form of aqueous film-forming foams (AFFF). Also, some PFASs are known to bio-accumulate in plants and animals. There is a growing body of evidence that exposure to PFASs can also cause a variety of health problems. Owing to these concerns, various world-wide regulatory agencies have started to establish strict limits to the presence of PFAS in food and water.

PFASs are a class of chemicals that contain perfluoroalkyl or polyfluoroalkyl groups. The definition and classification of PFASs has changed over time. PFASs are fluorinated substances that contain at least one fully fluorinated methyl or methylene carbon atom (without any H/Cl/Br/I atom attached to it), i.e. with a few noted exceptions, any chemical with at least a perfluorinated methyl group (—CF₃) or a perfluorinated methylene group (—CF₂—) is a PFAS. Some of the most important examples of PFASs include the perfluorosulfonic acids (PFSAs), such as perfluorooctanesulfonic acid (PFOS) and the perfluorocarboxylic acids (PFCAs) like perfluorooctanecarboxylic acid (PFOA). Fluorotelomers are fluorocarbon-based oligomers, or telomers, synthesized by telomerization. Some fluorotelomers and fluorotelomer-based compounds are a source of environmentally persistent perfluorinated carboxylic acids such as PFOA.

The persistence of PFASs, the health issues, and the regulatory landscape have prompted a great deal of research effort to reduce their presence in the environment. Much of the early work was focused on capture, for example from drinking water. However, more recently, there has been a stronger effort on the destruction of these materials. One of the attributes of PFASs is their resistance towards breaking down in the environment. PFASs are not easily metabolized by organisms, and do not decompose by exposure to visible light or longer wavelength UV irradiation typically found under terrestrial conditions.

Some of the methods that have proven effective for breaking down PFASs are supercritical water oxidation (SCWO) and treatment of PFASs in an aprotic polar solvent. SCWO works by heating water to 374° C. under high pressure (over 3000 psi). Therefore, SCWO is quite energy intensive and can suffer from clogging issues. The use of SCWO often requires wastes containing high solids because it relies on the heat capacity (btu) generated from this waste to make the process cost effective. An advantage of SCWO is its short residence time to be effective, on the order of 30 seconds to minutes. The use of basic aprotic media to destroy PFASs suffers from the fact that most waste streams are water-based and therefore not readily transferred to aprotic media that requires minimum water levels. In other cases, generating subcritical water conditions in alkaline environments has also been shown to destroy PFAS compounds. This process, referred to as hydrothermal alkaline treatment (HALT), operates at temperatures around 350° C. and pressures around 2400 psi.

Other processes for destroying PFASs involve the use of electrochemistry. Electrochemical destruction can destroy long chain PFASs (for example, PFOS and PFOA), however, shorter chain PFASs are less prone to destruction. It is speculated that the longer chained PFASs readily assemble on the electrodes and therefore can be readily oxidized or reduced. Other work has shown that sonication can result in PFAS destruction.

Improved processes are needed to efficiently and effectively destroy PFAS, particularly PFAS in water.

### SUMMARY

Various embodiments include methods and systems for treating wastewater for PFAS reduction including mixing wastewater including PFAS with an oxidizing species to form a treatment solution and exposing the treatment solution to UV light from a UV light source for an adequate time and at a sufficient intensity to destroy the PFAS. The method may further include mixing the wastewater with an acid or a base prior to exposing the treatment solution to UV light. In some embodiments, the oxidizing species includes a persulfate ion. The UV light source may be an excimer lamp, such as a krypton/chloride excimer lamp. The peak emission of the UV light source may be at about 222 nm.

The wastewater treated in various embodiments may include a mixture of many PFAS substances or essentially only one PFAS substance, some or all of which may be reduced using the methods described herein.

In some embodiments, the wastewater may include a polymeric PFAS which is reduced by the treatment methods. In some embodiments, the PFAS may include a perfluoroalkyl carboxylate. In some embodiments, the PFAS may include a partially fluorinated perfluoroalkyl carboxylate. In some embodiments, the PFAS may include a perfluoroalkyl alkoxide or a perfluoroalkyl alcohol.

In some embodiments, the wastewater which is treated may include wastewater produced during semiconductor manufacturing and the PFAS produced during semiconductor manufacturing may be destroyed by the methods and systems described herein.

Various embodiments also include methods and systems of treating wastewater include mixing wastewater including compounds containing either a trifluoromethyl group or a difluoromethylene group with an oxidizing species to form a treatment solution, and exposing the treatment solution to UV light for an adequate time and at a sufficient intensity to destroy the compounds.

Various other embodiments include methods and systems of continuously treating wastewater including mixing wastewater including PFAS with an oxidizing species to form a treatment solution, and exposing the treatment solution to UV light for an adequate time and at a sufficient intensity to destroy the PFAS while continuously flowing the treatment solution through a reactor from an inlet to an outlet of the reactor. The method may further include mixing the wastewater with an acid or a base prior to exposing the treatment solution to UV light. In some embodiments, the oxidizing species may be a persulfate ion.

### BRIEF DESCRIPTION OF THE DRAWINGS

While the specification concludes with claims particularly pointing out and distinctly claiming the subject matter that is regarded as forming the various embodiments of the present disclosure, it is believed that the disclosure may be better understood from the following description taken in conjunction with the accompanying Figures, in which:

FIG. 1 shows examples of sulfonic acid/sulfonate, carboxylic acid/carboxylate, phosphonic acid/phosphonate, and phosphinic acid/phosphinate PFAS types which may be used in various embodiments;

FIG. 2 shows examples of sulfonamide/sulfoanamido PFAS types which may be used in various embodiments;

FIG. 3 shows examples of alcohol/phosphate/phosphinic PFAS types which may be used in various embodiments;

FIG. 4 shows examples of R_{f} and R_{f1} which are defined as fluorinated alkyl, fluorinated aryl, fluorinated aralkyl, or fluorinated ether groups according to various embodiments;

FIG. 5 shows a general polymeric PFAS structure which may be used in various embodiments;

FIG. 6 shows a representative structure for acrylate polymer PFAS which may be used in various embodiments;

FIG. 7 is a graph defluorination percentage of semiconductor manufacturing wastewater after photo-oxidation with UV254 nm and UV222 nm;

FIG. 8 is a graph of the persulfate dosage dependence of defluorination percentage (DeF %) of semiconductor manufacturing wastewater in photo-oxidation after UV254 nm and UV222 nm;

FIG. 9 is a graph comparing of defluorination percentage (DeF %) of semiconductor manufacturing wastewater after thermal oxidation and photo-oxidation with UV254 nm and UV222 nm;

FIG. 10 is a graph comparing defluorination percentage (DeF %) of 4:2 FTS after photo-oxidation with UV254 nm and UV222 nm at acidic, neutral, and basic pH conditions;

FIG. 11 is a graph comparing defluorination percentage (DeF %) of PFOA after photo-oxidation with UV254 nm and UV222 nm at acidic, neutral, and basic pH conditions;

FIG. 12 is graph comparing defluorination percentage (DeF %) of 4:2 FTS between UV-based persulfate oxidation (Oxidation) and direct photolysis with UV254 nm and UV222 nm;

FIG. 13 is graph comparing of defluorination percentage (DeF %) of PFOA between UV-based persulfate oxidation (Oxidation) and direct photolysis with UV254 nm and UV222 nm;

FIG. 14 is a graph comparing defluorination percentage (DeF %) of semiconductor manufacturing wastewater between UV-based persulfate oxidation (Oxidation) and direct photolysis with UV254 nm and UV222 nm;

FIG. 15 is a graph comparing defluorination percentage (DeF %) between UV-based persulfate oxidation at UV222 and UV254; and

FIG. 16 is a graph showing the destruction of PFOS with UV-based oxidation at UV222 nm and 150 mM of potassium persulfate at a pH of 3.

### DETAILED DESCRIPTION

The following detailed description is exemplary in nature and is not intended to limit the scope, applicability, or configuration of the invention. Rather, the following description provides practical illustrations for implementing various exemplary embodiments. Utilizing the teachings provided herein, those skilled in the art may recognize that many of the examples have suitable alternatives.

The systems and methods described herein relate to processes for the oxidative photochemical destruction of PFASs.

Various embodiments disclosed herein include systems and methods of treatment of waste streams including PFAS using UV photoreduction in an advanced oxidation process (AOP). The treatment processes may include the generation of SO₄⁻· in the presence of contaminants such as PFAS. In various embodiments, the SO₄⁻· may be generated from persulfate ion. For example, contaminants such as contaminated water including water contaminated by PFAS may be combined with persulfate ion (S₂O₈²⁻), such as by mixing, and the persulfate ion may be activated to form SO₄⁻· such as through exposure to UV light. As described further below, the SO₄⁻· may then cause destruction of the contaminant such as PFAS.

Compared to other oxidation methods such as chemical oxidation (e.g., ozone, hydrogen peroxide, and hypochlorite, etc.), the advanced oxidation processes (AOPs) used in various embodiments may be characterized by the generation of highly reactive species such as hydroxyl radicals (·OH) and sulfate radicals (SO₄⁻·) in the treatment process. Due to their high oxidation potential, the ·OH and SO₄⁻· are capable of degrading a wide range of wastewater pollutants.

Various embodiments use persulfate in the advanced oxidative process. In these persulfate-based AOPs, the oxidation process may use persulfate ion (S₂O₈²⁻) as an oxidizing agent. Through certain activation methods, SO₄⁻· may be generated from persulfate. Activation methods for persulfate that may be used in various embodiments include heat, UV light, and/or transition metals (e.g., iron) activation, for example. The generated SO₄⁻· and ·OH are highly reactive and may effectively degrade various contaminants in water including PFAS.

Other species may alternatively or additionally be used as an oxidizing agent for example hydrogen peroxide, ozone, dibenzoyl peroxide, methyl ethyl ketone peroxide, sodium hypochlorite, and/or peroxyacetic acid.

The use of persulfate ion for AOPs provides several advantages. One significant advantage of persulfate-based oxidation is the stability of persulfate ion in storage and its ability to be activated on-site. This makes persulfate ion a useful and practical choice for various applications such as water treatment applications.

Among the available persulfate activation methods, UV-based activation of persulfate is particularly useful due to its advantages in mild reaction conditions and efficient radical generation. UV light provides the energy needed to cleave the O—O bond in persulfate (S₂O₈²⁻)), leading to the formation of highly reactive sulfate radicals (SO₄⁻·). At basic conditions, the generated SO₄⁻· is further converted into ·OH.

The intensity and wavelength of UV light can be precisely controlled, allowing for the optimization of radical production and treatment efficiency in various embodiments. For example, in some embodiments, UV light may be applied at 185 nm, 222 nm, and/or 254 nm. For example, the intensity and wavelength may be selected depending upon the target contaminant or contaminants being treated, among other things.

Various embodiments include methods of destroying contaminants such as PFAS in wastewater by mixing the wastewater with a persulfate at a sufficient concentration to form a treatment solution and activating the persulfate by exposing the treatment solution to UV light at a selected wavelength and sufficient intensity to generate a high enough level of SO₄⁻·. Some embodiments further include modifying the pH of the treatment solution by mixing an acid or base with the wastewater and persulfate to form the treatment solution. For example, the pH may be adjusted through the addition of acid to be between about 0 and about 3, or between about 3 and about 5, or between about 5 and about 7 (such as if the wastewater is basic). In other example, the pH may be adjusted through the addition of base to be between about 5 and 7 (such as if the wastewater is acidic), between about 7 and about 9, or between about 9 and about 13. In other examples, the pH of the wastewater may not be adjusted and AOPs may be performed without the addition of acid or base to the treatment solution.

Various embodiments include processes to increase the efficiency of the photochemical destruction of PFAS and allow photochemical methods to be more generally used on a variety of PFAS-containing waste streams. Other embodiments include UV photolysis reactor designs to accomplish more efficient destruction of PFASs.

In some embodiments, the AOPs may be used to treat PFAS present in wastewater or other water sources directly, such as in a high throughput treatment system. In other embodiments, the AOPs may be used to treat PFAS which has been extracted or absorbed and isolated and/or concentrated from the environment, such as from wastewater or other water sources. This PFAS may be suspended or dissolved into an aqueous solution for use in the AOP methods and systems described herein. Although various references are made herein to the treatment of wastewater, the same methods and systems may be used to treat PFAS from other sources and/or isolated from wastewater.

The methods and systems of PFAS destruction described herein include the ability to destroy PFAS contaminants, including carboxylated and sulfonated PFAS contaminants. Examples of PFAS which may be destroyed by the embodiments described herein include but are not limited to Trifluoroacetic Acid (TFA), Perfluorobutanoic acid (PFBA), perfluoropentanoic acid (PFPeA), Perfluorohexanoic acid (PFHxA), Perfluorooctanoic acid (PFOA), Perfluorobutanesulfonic acid (PFBS), Perfluorohexanesulfonic acid (PFHxS) and Perfluorooctanesulfonic acid (PFOS). More than one type of PFAS may be treated and destroyed simultaneously using the photoreaction methods described herein.

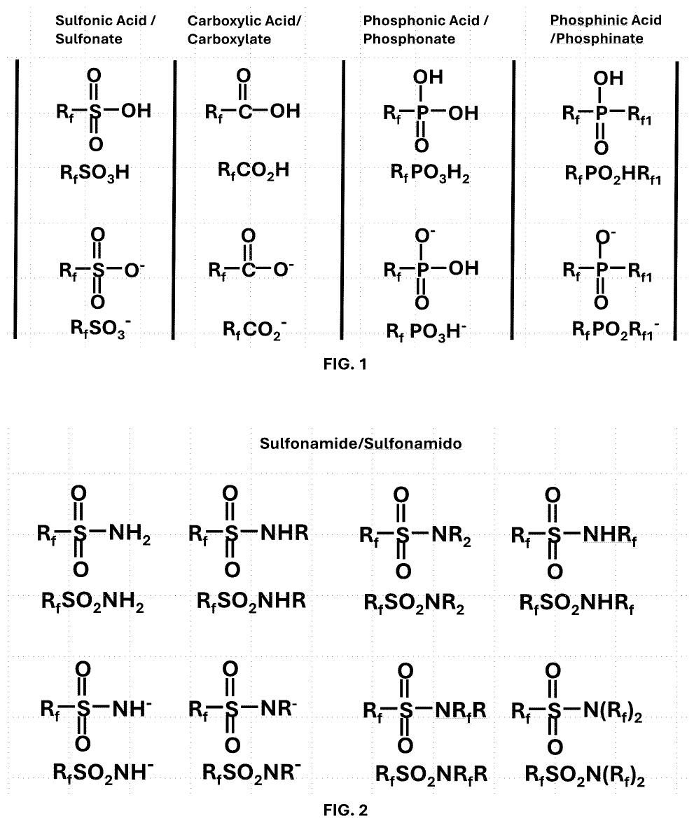

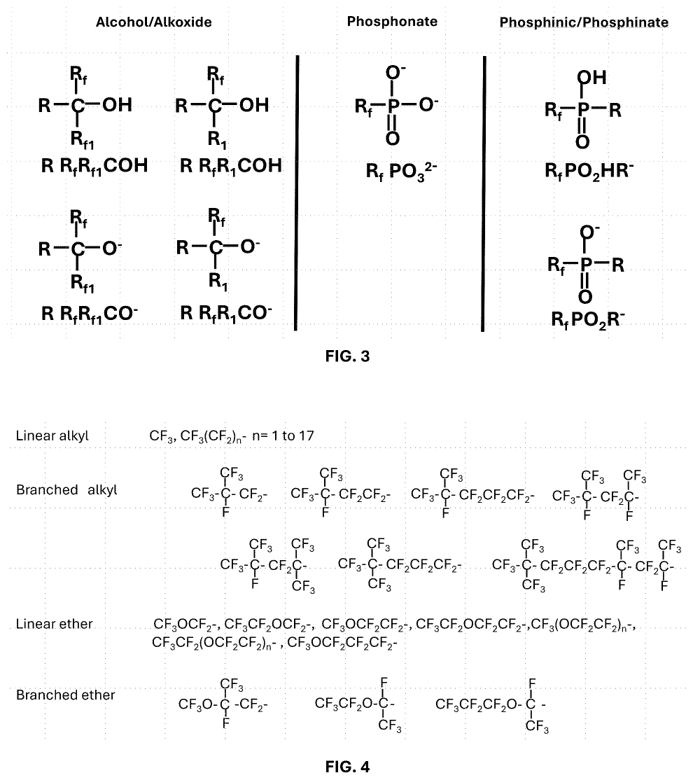

Some representative examples of different PFAS classes which may be treated and destroyed according to various embodiments are shown in FIGS. 1, 2 and 3 and described below. Common PFAS materials that may be destroyed according to various embodiments include carboxylic acid/carboxylates, sulfonic acid/sulfonates phosphonic acid/phosphonate and phosphinic acid/phosphinates derivatives shown in FIG. 1, for example. Perfluoroalkyl phosphonic acids are called PFPAs with a general structure of R_{f}PO₃H₂ and perfluoroalkyl phosphinic acids are called PFPiAs. Another class of PFAS are the sulfonamides shown in FIG. 2. Some examples of sulfonamides are perfluorooctanesulfonamide (PFOSA) and perfluorobutanesulfonamide (FBSA). FIG. 3 shows representative structures for PFAS alcohols/alkoxides, a PFAS phosphate dianion, and variations of PFAS phosphinic and phosphinate structures.

In the above FIGS. 1, 2 and 3, R_{f} and R_{f1} may be fluorinated alkyl, fluorinated aryl, fluorinated aralkyl, or fluorinated ether groups. R and R₁ may refer to alkyl, aryl, aralkyl or ether groups. Perfluoroalkyl phosphinic acids (PFPiAs) with a general structure of R_{f}PO2HR_{f1} may have two different fluorinated groups where R_{f} and R_{f1} are independently a fluorinated linear or fluorinated branched alkyl, aryl or aralkyl group or fluorinated ether group. Some phosphinates may have one fluorinated group, R_{f}, and one alkyl, aryl or aralkyl group, R. Representative examples of R_{f} and R_{f1} are shown in FIG. 4. These include linear and branched alkyl, aryl and aralkyl groups. Linear and branched ethers (shown in FIG. 4) are also quite common and may be included in PFAS destroyed according to various embodiments. The alkyl groups, R and R₁ may be further substituted with halogens, esters, ethers, amides and carboxylate groups. Any of these PFAS may be destroyed according to various embodiments.

The structures in FIGS. 1-3 are meant to be representative and not limiting examples of PFAS which may be destroyed according to various embodiments. For example, N-ethyl perfluorooctanesulfonamido acetate (EtFOSAA), where an acetate group (—CH₂COOH) is bound to the nitrogen instead of a simple alkyl group, may be considered within the scope of the invention. Similarly, in analogy with the sulfonamides, the corresponding amide derivatives of phosphonic acid/phosphonate and phosphinic acid/phosphinate may be included in various embodiments.

Compounds with the general structure R_{f}CO₂H or the corresponding conjugate base R_{f}CO₂⁻, where R_{f} is a linear fluoroalkyl group (e.g. CF3, CF₃(CF₂)ₙ where n=1-12 or branched fluoroalkyl group e.g. (CF₃)₂CF(CF₂)ₙ a fluoroether (e.g. CF₃O(CF₂)₂, CF₃CF₂O(CF₂)₂, CF₃CF₂O(CF₂)₃) may be very efficiently destroyed by 222 nm irradiation. Also, compounds with the general structure R_{f}(CH₂)ₘCO₂H, m=1-4 and R_{f}(CH₂)ₘSO₃H or the respective conjugate bases R_{f}CH₂)ₘCO₂⁻ and R_{f}CH₂)ₘSO₃⁻ may be readily destroyed by the oxidative process at 222 nm. Compounds containing the (CF₃)₂COH moiety (e.g. CH₃(CF₃)₂COH or C₆HCH₂(CF₃)₂COH) or a polymer with a (CF₃)₂COH moiety attached to the polymer by a linking group may be destroyed by the photooxidation process. Compounds containing R_{f}SO₃H and R_{f}SO₃⁻ may be more resistant to destruction. For example, in some cases, such compounds may require days of photolysis to destroy the parent compound.

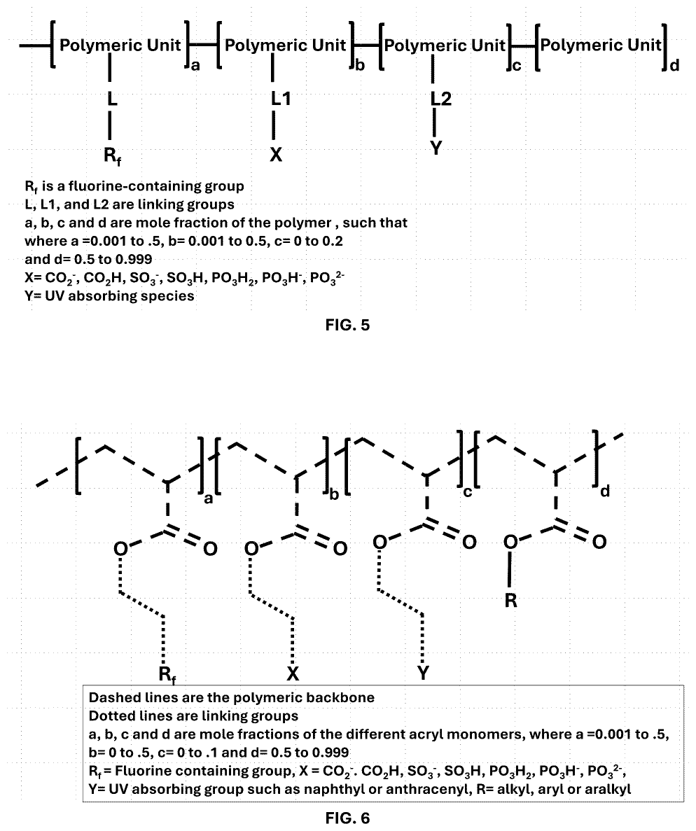

PFAS macromolecules may also be destroyed by the methods and systems described herein. For example, aqueous solutions of polymers with pendant fluorinated groups may also be oxidized and destroyed by the use of 222 nm radiation and the persulfate anion. FIG. 5 shows a general structure for a PFAS-containing polymer which may be destroyed according to various embodiments. In this structure the PFAS containing moiety is connected to the backbone of the polymer through a linking group. In many cases, these polymers are multifunctional. For example, these polymers may include “non-functional” backbone polymeric units. R_{f} may be any fluorine containing unit such as a fluorinated alkyl, fluorinated aryl, fluorinated aralkyl, or fluorinated ether groups or (R_{f})₂COH moiety, for example (CF3)₂COH. X represents either a —CO₂H, —CO₂⁻, —SO₃H, —SO₃⁻, PO₃H₂, PO₃H⁻ or PO₃²⁻ group that increase the water solubility or water dispersibility of the polymer. In other cases, there might be polymeric units with pendant UV absorbing entities. Examples of Y include naphthyl, anthracenyl, anthraquinonyl, or the radical of thiophene (also called thiophenyl). Although Y can also be any UV absorbing species that absorbs UV light between 250 nm and 400 nm. The entity that attaches the backbone to the functional entity is called a linking group represented by L, L1 and L2. The simplest linking groups are methylene (—CH2-), ethylene (—CH₂CH₂—) or more generally, alkylene (—(CH₂)ₙ—), where n is between 1 and 18. Other common linking groups are ethers for example; —CH₂CH₂—OCH₂CH₂— or —CH₂CH₂—OCH₂CH₂OCH₂CH₂—. The linking group may contain other functional groups such as esters, amides or halogens. The key feature of the linking group is its ability to connect the polymeric backbone to a functional group.

In some embodiments, the PFAS polymers may generally have greater than 50% (mole fraction ˜0.5) of the polymer units which may not be substituted, the PFAS containing polymeric unit containing X may make up 0.1 to 20% (mole fraction 0.001 to 0.5), the water solubilizing polymeric unit containing Y may make up 0.1 to 20% (mole fraction 0.001 to 0.5) and the UV absorbing polymeric unit may make up 0 to 10% (mole fraction 0 to 0.1) of the polymer. The polymer may be a random copolymer, where all the units may be randomly arranged or a block co-polymer where blocks of similar functionality may be adjacent to one another. General PFAS polymer structures which may be oxidized and destroyed according to various embodiments are shown in FIG. 5.

An example of a more specific PFAS-containing polymer which may be oxidized and destroyed according to various embodiments is shown in FIG. 6. In this case the polymer is an acrylate polymer and the linking groups are ethylene (—CH₂CH₂—).

Alternatively, some other examples of PFAS structures which may be oxidized and destroyed according to various embodiments can be represented as described in the following paragraphs.

The PFAS may be R_{f}—X, in which: R_{f} is selected from a linear, branched or cyclic perfluoroalkyl groups, or a linear or branched perfluoroetheralkyl groups, or hydrofluorinated group (e.g., contains one or more —CHF— or —CH₂— group), or halogen-substituted polyfluorinated group (e.g., contains one or more —CClF—, —CBrF—, or —CIF—) or combinations thereof; X is selected from —COOH or —COO⁻; —CONH₂; —CONHR, where R is an alkyl, aryl or alkaryl group; —SO₃H or —SO₃⁻ or —SO₂NH₂, —SO₂NH⁻, —SO₂NHR, —SO₂NR⁻, or —PO₃H₂ or —PO₃H⁻ or —PO₃²⁻.

The PFAS may be R_{f}—(CH₂)ₙ—X, in which: n is an integer from 1 to 10; R_{f} is selected from a linear, branched or cyclic perfluoroalkyl group, or a linear or branched perfluoroetheralkyl groups, or hydrofluorinated group (e.g., contains one or more —CHF— or —CH₂— group), or halogen-substituted polyfluorinated groups (e.g., contains one or more —CClF—, —CBrF— or —CIF—) or combinations thereof; and X is selected from —COOH, —COO⁻, —SO₃H or —SO₃⁻; —SO₂NH₂, —SO₂NH⁻, —SO₂NHR, —SO₂NR⁻, PO₃H₂, PO₃H⁻ or PO₃²⁻.

The PFAS may be R_{f}—(CH₂)ₙ—PO₂H—(CH₂)ₙ₁R_{f1} or [R_{f}—(CH₂)ₙ—PO₂—(CH₂)ₙ₁R_{f1}]⁻, in which: n and n1 are an integer from 1 to 10; and R_{f} and R_{f1} are independently selected from a linear, branched or cyclic perfluoroalkyl groups, or a linear or branched perfluoroetheralkyl groups, or hydrofluorinated group (e.g., contains one or more —CHF— or —CH₂— group), or halogen-substituted polyfluorinated groups (e.g., contains one or more —CClF—, —CBrF— or —CIF—) or combinations thereof.

The PEAS may be R_{f}(R_{f1})(R)—C—OH in which: R_{f}, R_{f1}, and R are bound to the carbon; R_{f} and R_{f1} are independently selected from a linear, branched or cyclic perfluoroalkyl groups; or a linear or branched pertluoroetheralkyl groups, or hydrofluorinated group (e.g., contains one or more —CHF— or —CH₂— group), or halogen-substituted polyfluorinated groups (e.g., contains one or more —CClF— or —CBrF—) or combinations thereof; and R is an alkyl, aryl, alkaryl group.

The PEAS may be R_{f} (R_{f1})(R)—C—OH in which: R_{f}, (R_{f1}), and (R) are bound to the carbon; L is a linking group that connects to a polymeric backbone, for example a —CH₂CH₂—, —CH₂CH₂CH₂—; and Polymeric backbone is an acrylate or polyurethane.

Destruction of the PFAS includes a change in the identity of the target chemical pollutant through the cleavage of chemical bonds. Destruction that yields complex chemical compounds as final products is referred to as degradation. Destruction includes removing one or more chemical groups to reduce or eliminate toxicity.

The PFAS used in various embodiments may be in aqueous solution, such as PFAS present in a water from a contaminated natural source or other source or may be concentrated by a prior capture or pretreatment method or other treatment method.

PFASs are found in many waste streams. Some common PFAS-containing waste streams include effluent from industrial producers of PFASs, effluent from textiles plants, foam fractionation concentrates, Aqueous Film-Forming Foams (AFFF), AFFF rinsates, landfill leachates, contaminated ground water, municipal water waste streams and pot still bottoms. Any of these waste streams may be used in the treatment methods disclosed herein.

In some embodiments, the systems and methods may be used to treat PFAS present in wastewater or other water sources directly, such as in a high throughput treatment system. In other embodiments, the treatment systems and methods may be used to treat PFAS which has been extracted or absorbed and isolated and/or concentrated from the environment, such as from wastewater or other water sources. This PFAS may be suspended into an aqueous solution for use in the methods and systems described herein.

In some embodiments, the oxidative treatment processes disclosed herein may be particularly useful for the treatment of perfluoroalkyl carboxylate PFCA. For example, in some embodiments, the oxidative treatment processes may be used for treatment of waste streams that include only perfluoroalkyl carboxylate PFCA and do not contain sulfonate PFAS (or virtually no sulfonate PFAS such as only trace amounts of sulfonate PFAS at a level below that which treatment is required, such as below 50 ppt or preferably below 100 ppt. For example, the oxidative treatment processes disclosed herein may be used to treat wastewater including PFAS polymers used in the semiconductor industry, such as those used as Top Anti-Reflective Coatings (TARCs) in chip manufacturing.

In some embodiments, the oxidative treatment processes disclosed herein may be used to treat waste streams including only one PFAS contaminant which is the target PFAS for treatment (with any other PFAS virtually absent or at levels so low that treatment is not required, such as below 50 ppt and preferably below 10 ppt) or a single dominant PFAS target contaminant forming about 80% or more, of about 90% or more, or about 95% or more, or about 99% or more of all PFAS or of all contaminants in the waste stream. For example, the waste stream may be produced during an industrial process, such as semiconductor production, and may therefore be present as a single dominant contaminant requiring destruction before release of the treated water. For example, the target contaminant may be a perfluoro carboxylate (CₙF₂ₙ₊₁COO⁻, n=1˜20). In some embodiments, the target contaminant may be a fluorotelomer sulfonate (CₙF₂ₙ₊₁—CH₂CH₂—SO₃⁻, n=1˜20). In some embodiments, the target contaminant may be a fluorotelomer carboxylate (CₙF₂ₙ₊₁—CH₂CH₂—COO⁻, n=1˜20). An example of a PFAS is 2:4 FTS with a chemical formula of 1H,1H,2H,2H-perfluorohexanesulfonic acid. In some embodiments, the target contaminant may be a high molecular weight PFAS, such as a product of chip manufacturing such as a TARC material.

The conditions used for oxidative treatment processes disclosed herein may be tailored to the target contaminant, including, for example, the persulfate concentration, the pH and the light conditions (intensity, duration, etc.). For example, the treatment of fluorotelomer sulfonates and fluorotelomer carboxylates such as 4:2 FTS may be performed at a pH of about 5 to about 7. The treatment of perfluorocarboxylic acids (PFCAs) such as PFOA may be performed at a pH of about 0 to about 3. The treatment of high molecular weight PFAS such fluoroalcohol methacrylate polymers such as TARC materials may be performed at a pH of about 5 to about 7.

The advanced oxidative processes described herein may be performed in a treatment vessel such as in a treatment vessel for UV treatment at standard or atmospheric temperature and pressure, though in alternative embodiments, the treatment vessel may provide or be configured to provide UV treatment at an elevated temperature and optionally also at elevated pressure.

Various embodiments employ a photoreactor including a light source which delivers a narrow range of ultraviolet light radiation with a peak at approximately 222 nm, such as a krypton/chloride excimer lamp. However, other wavelengths of light may also be used, alone or in combination. For example, the reactor vessel may include one or more UV light sources emitting light, such as UV light at a peak of about 222 nm and/or UV light at a peak of about 254 nm. In some embodiments, multiple wavelengths may be emitted from a light source, or from various light sources, and other wavelengths of lights in addition to 222 nm and 254 nm may contribute to PFAS photo-destruction, such as 185 nm.

In some embodiments, the UV photoreduction process may be performed using one or more reactor vessels with one or more UV light sources. The reactor may be charged with a wastewater including PFAS, persulfate, and optionally with an acid or base. In some embodiments, one or more of the reactor vessels may be a continuous reactor such as stirred tank reactor vessels or a cylindrical or tube reactor through which the treatment solution continuously flows from an inlet at one end to an outlet at an opposite end while exposed to UV light for continuous PFAS treatment, such as by flowing around and between lamps submerged within the treatment solution in the reactor. The reactor solution may be stationary during UV treatment, or it may be agitated. For example, the reactor may include stirrers or agitators with the capacity to stir or agitate the solutions. In some embodiments, stirring or agitating the reactor solution during irradiation may facilitate exposure of PFAS compounds to regions of higher radiation. Ultimately, optimization of reactor solution for efficiency may also depend upon direct agitation or stirring of the compound to expose more solution constituents to a region of higher radiation field in a smaller amount of time.

The UV reactor may further include a recirculating system which may be equipped with a heat-exchange system configured to control the solution temperature. In some embodiments, the AOP may be performed at room temperature, while in other embodiments, the AOP may be performed at an elevated temperature, such as a temperature up to but less than 100 degrees C., such as about 25 degrees C. to about 95 or about 99 degrees C., or at about 55 to about 60 degrees C. The UV reactor may further include a sensor module configured to allow continuous monitoring of the physical and/or chemical state of the reaction solution. In some embodiments, the UV reactor may also include one or more ports for adding additional reagents and/or sampling the reaction mixture. In addition, heating and/or cooling elements could be added to the reactor and/or to the room containing the reactor to raise or lower the temperature, such as air-ducting, fans and lamps.

The photoreactor may be used alone, or in combination with other reactors, such as in a serial configuration, which may also employ a photoreduction at the same or different wavelength or may employ other PFAS destruction methodologies. Alternatively, one or more steps may be performed in the same vessel.

Examples of PFAS capture systems, treatment systems, and pre and post treatment systems and methods are provided in the applicant's other applications, such as U.S. patent application Ser. No. 18/771,104 entitled Methods and Systems of PFAS Destruction using UV Irradiation at 222 nm, filed Jul. 12, 2024, which is hereby incorporated by reference in its entirety. The treatment methods and systems described herein may be used in combination with the methods and systems described in this application. For example, one or more of the systems and method of pretreatment including nitrogen removal, oxidative pretreatment, and/or settling and separation of solids may be used before the treatment methods and systems described herein. The treatment methods such as UV irradiation using a sulfite and a sensitizer such as a halide and/or photoelectric treatment may be used as additional treatment steps, in combination with the treatment methods and systems described herein, such as before or after the treatment systems and methods described herein. Post treatment systems and methods such as capture and recycling of reactants and/or removal of fluoride may be used in combination with the treatment methods and systems described herein. In some embodiments, one or more pretreatment, treatment and/or post treatment methods or systems may be used in combination with the treatment systems and methods described herein. Different systems and methods may be employed for each of these steps, in various combinations. While all of the steps may be used in some cases, in other cases a system of methods may not include all of these steps. Furthermore, the systems and embodiments may further include means for fluid transportation including pipes, pumps, valves, inlets, outlets, etc., such as to connect various components and connect to and from inlets and outlets of various components.

In some embodiments, an effective method and system for photochemically destroying PFASs may include the following steps: photolysis including AOPs as described herein followed by post treatment including capture and recycling of persulfate and/or fluoride remediation. For example, after treatment using AOPS, persulfate may be captured, alone or in combination with remaining PFAS or PFAS breakdown products, such as through the use of one or more selective filters or membranes such as reverse osmosis (RO) filters. The filter reject(s) including the persulfate and/or PFAS may be cycled back into the AOP reactor, where it may optionally be combined with additional untreated wastewater, and subjected to AOP again. In this way, additional persulfate addition may not be required, or less additional persulfate may be required, and any remaining PFAS may be further treated for additional breakdown, while the permeate may be clear of PFAS or sufficiently clear of PFAS and may be released. In addition or alternatively, fluoride in the treatment solution may be remediated by AOPs, such as by precipitation and removal, such as in the form of fluorite or gypsum, before or after persulfate capture.

One example of a photoreactor which may be used in various embodiments comprises one or more lamps, such as lamps including cylindrical bulbs or other bulb shapes, and one or more photoreactor vessels configured such that the light of the lamp will project onto the contents of the reactor vessel or vessels. In some embodiments, the photoreactor may include many lamps, such as between 8 and 50 lamps. The lamps may be supported on a frame such as a metal support frame, at a desired distance over a top surface of a photoreactor vessel and/or above the top surface of liquid in the photoreactor vessel when in use to shine directly on the surface of the reaction solution or to shine through the reactor vessel wall. Alternatively, the lamp may fit into the reactor vessel to shine light directly onto the contents from within the reactor vessel. The bulb may be protected and/or separated from the reaction solution within the reactor vessel, such as by a sleeve or other barrier. In some embodiments, the photoreactor vessel may include two cylindrical lamps and a support frame holding the two lamps horizontally at a selected distance above a level surface of a photoreactor vessel. Other light and reactor vessel configurations and orientations may be used to optimize energy delivery and PFAS destruction.

The photoreactor vessel may be any appropriate material such as quartz or other material which is non-reactive and is transparent to 222 nm radiation. In other embodiments, such as those in which the bulb is located within the reactor vessel, the reactor vessel need not be transparent and may be a nontransparent and nonreactive material such as stainless steel. The vessel may be configured to contain a fluid and may include a top which may seal the vessel. In some embodiments, the photoreactor may include a single reactor vessel, while in others it may include more than one reactor vessel, such as two or three reactor vessels or more. The reactor vessel may be any size or shape. In some embodiments, the reactor vessel is cylindrical.

The lamp(s), lamp support, and the reactor vessel may be contained in a housing such as a metal enclosure or other enclosure.

Examples of lamps which may be used in various embodiments include krypton/chloride excimer lamps emitting radiation at 222 nm. Other excimer lamps which emit a narrow band of radiation at other wavelengths could alternatively be used. The lamps may consume 100 Watts of power or could consume more or less power. In some embodiments, the reactor systems may consume about 5 kilo Watts of power or more, such as about 15 kilo Watts or more, and multiple reactors may be used. The power supply to the lamps may be 20 kilovolts or may be more or less than 20 kilovolts. In some embodiments, the lamp powers for lamps including those emitting at 222 nm and 254 nm, for example, may be between about 50 and about 5000 W, such as between about 100 and about 1000 W or between about 100 and about 300 W. Single lamps may be used or multiple lamps, which may be identical or different.

The photoreaction methods as described herein may be performed at room temperature or at a temperature greater than room temperature. For example, in some embodiments, the temperature of the photoreactor may be between about 55 and about 60 degrees Celsius during the reaction. However, higher or lower temperatures could alternatively be used. In addition, heating and/or cooling elements could be added to the reactor and/or to the room containing the reactor to raise or lower the temperature, such as air-ducting, fans and lamps.

Some embodiments result in complete destruction of the PFAS or near complete destruction, such as greater than 99% destruction. Some embodiments result in at least 90% or at least 95% destruction of PFAS, such as about 90% to about 100%, or about 95% to about 100% destruction of PFAS.

The duration of treatment necessary to achieve complete destruction of the PFAS or near complete destruction may depend upon the design of the photoreactor which is used, as well as other variables.

One example of a UV reactor according to various embodiments includes a reactor providing greater than 1000 Ws of UV light and configured to maintain the solution at less than 50° C. The UV reactor includes a sensor module that may be configured to provide information to help maintain optimal photochemical conditions through a closed-looped control system to automatically maintain the conditions. The sensor system in some embodiments one or more sensors configure to monitor one or more of the following: temperature, pressure, pH, UV intensity, fluoride ion concentration, and oxidation-reduction potential.

The additives charged from the ports can be added either continuously or in one or more batches. Typical additives include persulfate and optionally acid and/or base.

Depending on the waste streams, it may be useful to perform both an oxidative treatment and a reductive treatment. Although these two treatments could be performed sequentially in the same vessel, they could also be performed in separate vessels. The sequence that these steps are performed in could vary depending on the components in the waste stream.

The AOPs used in various embodiments may destroy the PFAS through mineralization of the PFASs, including converting the carbon-fluoride bond to the fluoride ion and carbon species, such as acetate, carbon dioxide and/or carbonate. In this context mineralization may include reactions that result in the breaking of the carbon-fluorine bonds on PFAS to form the fluoride ion F⁻.

### EXPERIMENTAL

Some of the examples include the use of a semiconductor wastewater sample collected from Merck EMD (thereafter “Merck Wastewater”). This wastewater includes a high molecular weight fluoroalcohol merthacrylate polymer. The fluoroalcohol methacrylate polymer includes at least one crosslinkable moiety like a hydroxyl and/or a carboxyl group, at least one absorbing chromophore and an optional fluorinated group. Examples of monomers which may provide such a unit upon polymerization are without limitations, substituted or unsubstituted vinyl monomers containing a hydroxyl and or carboxyl group, such as acrylic acid, methacrylic acid, vinyl alcohol, hydroxystyrenes, vinyl monomers containing 1,1′,2,2′,3,3′-hexafluoro-2-propanol. The polymer may contain a mixture of monomer units containing hydroxyl and/or carboxyl groups. Other than the unit(s) containing the crosslinking group, the fluorinated group and the absorbing chromophore, the polymer may contain other monomeric units; such units may provide other desirable properties. Examples of the additional monomer are CR′1R′2 CR′3R′4-, where R′1, to R′4 are independently H, (C1-C10) alkyl, (C1-C10) alkoxy, nitro, halide, cyano, alkylaryl, alkenyl, dicyanovinyl, SO2CF3, COOD, SO3D, COD, OD, ND2, SD, SO2D, NHCOD, SO2ND2, where D is H, or (C1-C10) alkyl, hydroxy (C1-C10) alkyl, (C1-C10) alkylOCOCH2COCH3, or R′2 and R′4 combine to form a cyclic group such as anhydride, pyridine, or pyrollidone, or R′1, to R′3 are independently H, (C1-C10) alkyl, (C1-C10) alkoxy and R′4 is a hydrophilic group. This PFAS polymer is a representative photolithography agent used in semiconductors as a top anti-reflective coating (TARC). The TARC is a coating applied over the photoresist layer in photolithography. The purpose of employing TARC is to minimize the reflections from the top surface of the photoresist, thereby reducing standing waves and other interference patterns that can degrade the resolution and fidelity of the pattern transfer. In the semiconductor production line, TARC is used in the spin coat application, and Merck Wastewater is generated through the “spin bowl” collection. Background analysis showed that the metal ions in Merck Wastewater are below 1 ppb.

The total organic fluorine (TOF) in Merck Wastewater was determined as 495±10 ppm by Novem Scientific (2357 Ventura Drive, Suite 110, Woodbury, Minnesota 55125, USA). In brief, TOF values are calculated by subtracting the inorganic fluoride (IF) from total fluorine (TF). In Merck Wastewater, TF is measured at 501±10 ppm by combustion ion chromatography (CIC), and IF is determined at 6±0.4 ppm by ion chromatography (IC). In this case, the TOF value in Merck Wastewater is calculated at 495 ppm by subtracting IF (6 ppm) from TF (501 ppm).

Defluorination percentage (DeF %) was used to evaluate and compare the destruction performance of the treatment process. During the treatment process, free fluoride (F⁻) concentrations were determined by an ion-selective electrode (ISE, Fisher brand accumet solid-state) connected to a Thermo Scientific Orion Versa Star Pro meter. Then, the defluorination percentage (DeF %) is calculated based on the measured F⁻ by Equation 1 (Eq-1),

$$De F \% = \frac{{F}_{t}^{-} - {F}_{0}^{-}}{TO F} \qquad ( Eq - 1 )$$

where: Fₜ⁻ and F₀⁻ stand for F— concentration at time t and initial F⁻ concentration, respectively. The higher DeF % value generally indicates the better efficacy and favorable conversion efficiency of the treatment process in terms of converting organic fluorine in PFAS polymer into free F⁻.

Additional chemicals used in the examples (K₂S₂O₈, Na₂S₂O₈, PFOA, H₂SO₄, HCl) are reagent grade and were obtained from Sigma-Aldrich (St. Louis, MO).

### Example 1

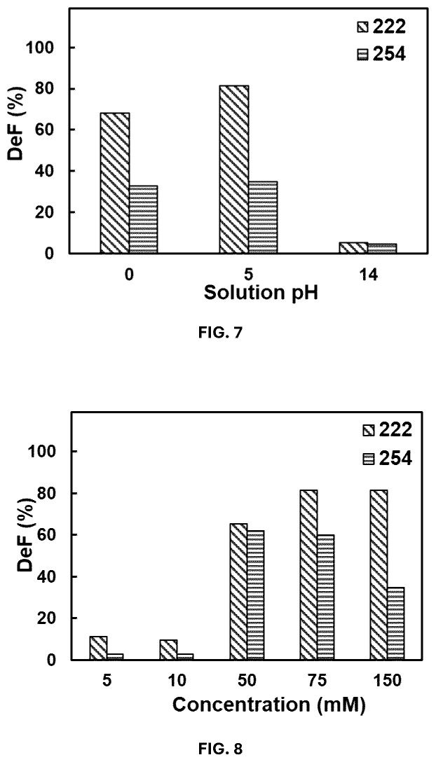

In this example, the pH of the solution was optimized for photo-oxidation of Merck Wastewater in UV254 nm and UV222 nm photoreactors, respectively. About 100 mL of Merck Wastewater was transferred into 100 mL quartz vials (QP062, Aireka Scientific Co., Ltd, HK). Each 100 mL solution was mixed with 4.05 g K₂S₂O₈ or 3.57 g Na₂S₂O₈ to make the final S₂O₈²⁻ concentration at 150 mM. After that, 2 mL of 1 M sulfuric acid was added to the sample for the acidic reaction conditions, and the resulting pH was measured at ˜0. No additional chemical was added to the sample for the neutral reaction conditions, and the pH was measured at ˜5. 2.98 g sodium hydroxide was added to the sample for the basic reaction conditions, and the resulting pH was measured at ˜14. Finally, the loaded solution was photolyzed in a UV254 nm photoreactor and a UV222 nm photoreactor. The UV254 nm photoreactor (LZC-ORG type, Luzchem Research Inc. Canada) was equipped with eight 10-watt UV254 nm lamps. The UV222 nm photoreactor was equipped with two 100-watt UV222 nm lamps. A detailed description of the UV222 nm photoreactor is provided in the applicant's other application U.S. patent application Ser. No. 18/771,104 referred to above. During photo-oxidation, 3 mL samples were taken from quartz vials for F⁻ quantification at appropriate time intervals. Then, the DeF % was calculated based on Eq-1. The results are seen in FIG. 7, which shows a comparison of defluorination percentage (DeF %) in photo-oxidation with UV254 nm and UV222 nm for Merck Wastewater under the following reaction conditions: 150 mM S₂O₈²⁻, solution pH was controlled at 0, 5, and 14, respectively, reaction time at 2 h.

From FIG. 7, it can be seen that UV222 nm photo-oxidation was more effective than UV254 nm in the tested pH range. In acidic conditions, the 2 h DeF % increased to 68.2% in UV222 nm photo-oxidation compared to only 32.8% in UV254 nm photo-oxidation. At pH 5, the 2 h DeF % in UV222 nm photo-oxidation is 81.5%, which is 2 times the DeF % in UV254 nm photo-oxidation (34.7%).

From FIG. 7, the optimized solution pH for Merck Wastewater in this example was at pH 5 in both UV222 nm and UV254 nm photo-oxidation. After 2 h UV222 nm photo-oxidation, the DeF % increased to 81.5% at pH 5, significantly higher than that in basic conditions (5.2%). The DeF % in acidic conditions (68.2%) is also slightly lower than at pH 5. Similarly, in UV254 nm photo-oxidation, the 2 h DeF % is the highest at pH 5 among all the tested pH range (34.7%).

### Example 2

In this example, the oxidant dosage was optimized in photo-oxidation for Merck wastewater at optimized pH conditions. About 100 mL of Merck Wastewater was transferred into 100 mL quartz vials (QP062, Aireka Scientific Co., Ltd, HK). The solution was then mixed with varied concentrations of persulfate at 5 mM, 10 mM, 50 mM, 75 mM, and 150 mM. No additional chemical was added to the sample, and the pH was measured at ˜5. Finally, the loaded solution was photolyzed in a UV254 nm photoreactor and a UV222 nm photoreactor, respectively (see more details about UV254 nm and UV222 nm photoreactors in Example 1). After 2 h reactions, 3 mL samples were taken from quartz vials for F⁻ quantification, and DeF % was calculated based on Eq-1. The results are presented in FIG. 8, which shows the persulfate dosage dependence of defluorination percentage (DeF %) in photo-oxidation with UV254 nm and UV222 nm for Merck Wastewater under the following reaction conditions: solution pH at 5, reaction time at 2 h, S₂O₈²⁻ concentrations at 5 mM, 10 mM, 50 mM, 75 mM, and 150 mM.

From FIG. 8, the 2 h DeF % in UV222 nm photo-oxidation is always higher than in UV254 nm photo-oxidation at the same persulfate dosage level. For instance, at 75 mM S₂O₈²⁻, the 2 h DeF % is 80.4% in UV222 nm photo-oxidation, while the DeF % is 58.6% in UV254 nm photo-oxidation. Similarly, at 150 mM S₂O₈²⁻, the 2 h DeF % is 81.5% in UV222 nm photo-oxidation, considerably higher than the 2 h DeF % in UV254 nm photo-oxidation (34.7%). It is believed that, at the highest persulfate dosage, excessive generated hydroxyl radicals may have reacted with each other (self-quenching), lowering the availability of hydroxyl radicals for PFAS degradation. As a result, the defluorination performance decreased a little at the highest persulfate dosage.

### Example 3

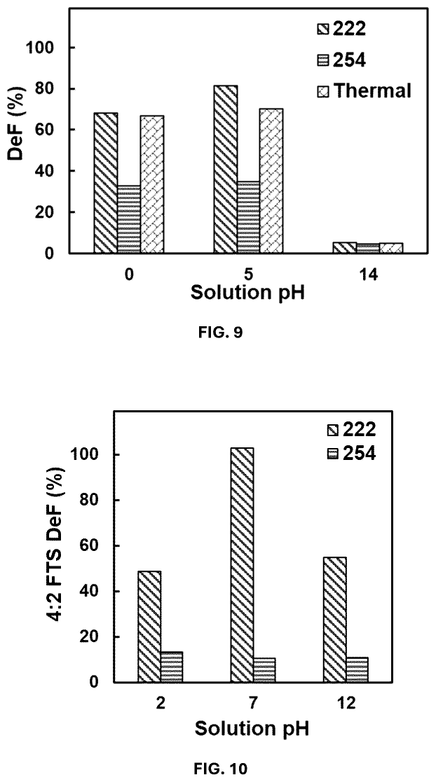

In this example, thermal/persulfate oxidation for Merck Wastewater was performed under different pH conditions and then compared to the treatment performance with photo-oxidation. For the thermal oxidation of Merck Wastewater, about 30 mL of Merck Wastewater was put into each glass pressure vessel and mixed with 1.21 g K₂S₂O₈ (150 mM S₂O₈²⁻). 0.6 mL of 1 M sulfuric acid was added to the sample for the acid reaction conditions, and the resulting pH was measured at ˜0. 0.9 g sodium hydroxide was added to the sample for the base reaction conditions, and the resulting pH was measured at ˜14. No additional chemical was added to the sample for the neutral reaction conditions. The pressure vessels were loosely sealed and heated to 120° C. at an elevated pressure of approximately 2 bar for 120 minutes. Free fluoride measurements were taken after the thermal reaction, and DeF % was calculated based on Eq-1. Thermal oxidation data is shown in comparison to photo-oxidation with UV222 nm and UV254 nm data in FIG. 9. FIG. 9 presents a comparison of defluorination percentage (DeF %) in thermal oxidation and photo-oxidation with UV254 nm and UV222 nm for Merck Wastewater under the following reaction conditions: 150 mM S₂O₈²⁻, solution pH was controlled at 0, 5, and 14, respectively, reaction time at 2 h.

From FIG. 9, UV222 nm photo-oxidation was more effective than UV254 nm photo-oxidation and thermal oxidation. Although the thermal oxidation exhibited comparable DeF % to UV222 nm photo-oxidation at selected pH conditions, the UV222 nm photo-oxidation has unique advantages including mild reaction conditions requirement (e.g., room temperature) and ease in equipment set-up.

### Example 4

In this example, the pH was optimized for 4:2 fluorotelomer sulfonate (4:2 FTS, C₄F₉—CH₂CH₂—SO₃H) photo-oxidation at UV222 nm and UV254 nm. A 100 mL quartz vial was filled with 10 μM 4:2 FTS, 0.5 mL of 1 M H2SO4, and 0.5 mM Na₂S₂O₈ for the acid reaction conditions. The neutral pH condition was prepared in a 100 mL quartz vial with 10 μM 4:2 FTS and 0.5 mM Na₂S₂O₈. Finally, the basic pH condition was prepared in a 100 mL quartz vial with 10 μM 4:2 FTS, 20 mM NaOH, and 0.5 mM Na₂S₂O₈. Each condition was run at UV222 nm and UV254 nm for 24 hours. The results presented in FIG. 10, which shows a comparison of defluorination percentage (DeF %) in photo-oxidation with UV254 nm and UV222 nm for 4:2 FTS at acidic, neutral, and basic pH conditions under the following reaction conditions: 10 μM 4:2 FTS, 0.5 mM S₂O₈²⁻ solution pH was controlled at 2, 7, and 12, respectively, reaction time at 24 h.

From FIG. 10, the optimized solution pH for UV222 nm photo-oxidation of 4:2 FTS was determined at neutral pH conditions (˜pH 7).

### Example 5

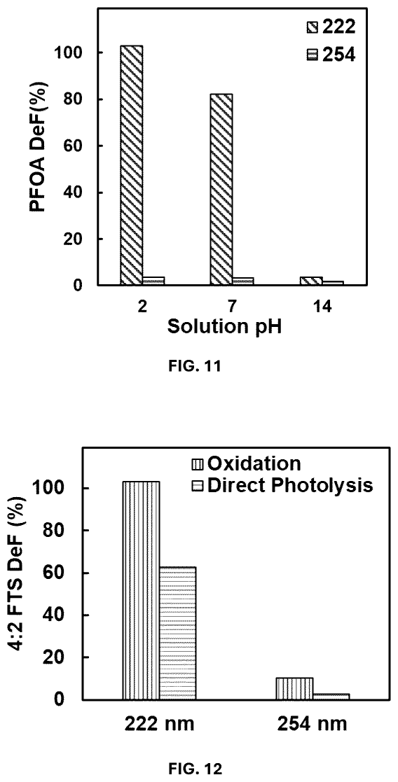

In this example, the pH was optimized for PFOA (C₇F₁₅—COOH) photo-oxidation at UV222 nm and UV254 nm. A 100 mL quartz vial was filled with 10 μM PFOA, 0.5 mL of 1 M H₂SO₄, and 0.5 mM Na₂S₂O₈ for the acid reaction conditions. The neutral pH condition was prepared in a 100 mL quartz vial with 10 μM PFOA and 0.5 mM Na₂S₂O₈. Finally, the basic pH condition was prepared in a 100 mL quartz vial with 10 μM PFOA, 3 g NaOH, and 0.5 mM Na₂S₂O₈. Each condition was run at UV222 nm and UV254 nm for 24 hours. The results are presented in FIG. 11, which shows a comparison of defluorination percentage (DeF %) in photo-oxidation with UV254 nm and UV222 nm for PFOA at acidic, neutral, and basic pH conditions under the following reaction conditions: 10 μM PFOA, 0.5 mM S₂O₈², solution pH was controlled at 2, 7, and 14, respectively, reaction time at 24 h.

From FIG. 11, it can be seen that the optimized solution pH for UV222 nm photo-oxidation of PFOA in this example was determined at acidic conditions (˜pH 2).

### Example 6

In this example, we compared UV-based persulfate oxidation to direct photolysis for Merck Wastewater, 4:2 FTS, and PFOA at optimized solution pH conditions (identified in previous examples). In direct photolysis experiments, only the Merck Wastewater, 4:2 FTS, and PFOA were individually added to the solution. The procedure for UV-based persulfate oxidation is the same as described in previous examples.

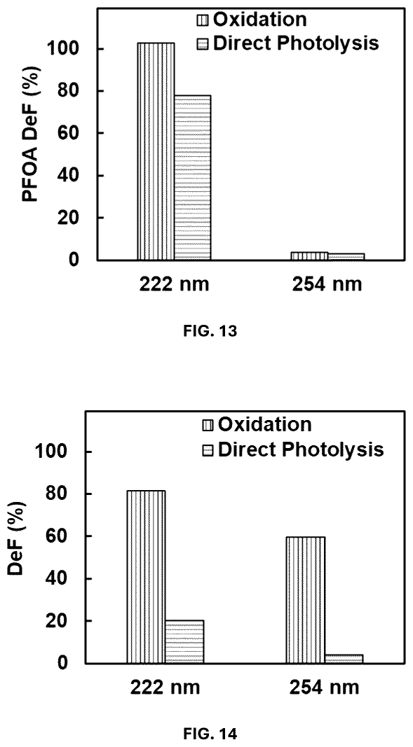

The results are shown in FIGS. 12-14. FIG. 12 shows a comparison of defluorination percentage (DeF %) between UV-based persulfate oxidation (Oxidation) and direct photolysis with UV254 nm and UV222 nm for 4:2 FTS under the following reaction conditions: 10 μM 4:2 FTS, 0.5 mM S₂O₈²⁻ for UV-based persulfate oxidation, optimized solution pH at 7, reaction time at 24 h. FIG. 13 shows a comparison of defluorination percentage (DeF %) between UV-based persulfate oxidation (Oxidation) and direct photolysis with UV254 nm and UV222 nm for PFOA under the following reaction conditions: 10 μM PFOA, 0.5 mM S₂O₈²⁻ for UV-based persulfate oxidation, optimized solution pH at 0, reaction time at 24 h. FIG. 14 shows a comparison of defluorination percentage (DeF %) between UV-based persulfate oxidation (Oxidation) and direct photolysis with UV254 nm and UV222 nm for Merck Wastewater under the following reaction conditions: Merck Wastewater, optimized solution pH at 5, 75 mM S₂O₈²⁻ for UV-based persulfate oxidation, reaction time at 2 h; The reaction time for direct photolysis is set at 24 h.

From FIGS. 12-14, it can be seen that UV-based persulfate oxidation outperformed direct photolysis at both wavelengths. As shown in FIG. 12, near-complete defluorination was achieved with UV222 nm/persulfate oxidation from 4:2 FTS, while the direct photolysis only obtained a DeF % of ˜60%. At UV254 nm photo-oxidation system, the UV254 nm/persulfate oxidation from 4:2 FTS achieved a DeF % of ˜10%, which was higher than ˜3% in direct photolysis of 4:2 FTS at UV254 nm photo-oxidation. A similar trend was observed for PFOA, a representative fully fluorinated carboxylate, where UV-based persulfate oxidation outperformed direct photolysis at both wavelengths (FIG. 13). In FIG. 14, where Merck wastewater was used as a model material for fluoropolymer wastewater, again there was higher defluorination from UV-based persulfate oxidation than direct photolysis. The 2 h DeF % from photo-oxidation of Merck Wastewater was 61˜81%, which was considerably higher than that in direct photolysis at 24 h (FIG. 14).

### Example 7

In this example, UV-based persulfate oxidation at UV222 nm was compared to UV254 nm for 4:2 FTS, PFOA, and Merck wastewater at optimized pH conditions. In brief, in each 100 mL quartz vial, 10 μM PFOA solution was mixed with 5 mM H₂SO₄ and 0.5 mM S₂O₈²⁻; 10 μM 4:2 FTS solution was mixed with 0.5 mM S₂O₈²⁻ for neutral reaction conditions and Merck Wastewater was mixed with 75 mM S₂O₈²⁻. All the vials were placed under either UV222 nm or UV254 nm for 24 hours (see more details about UV254 nm and UV222 nm photoreactors in Example 1).

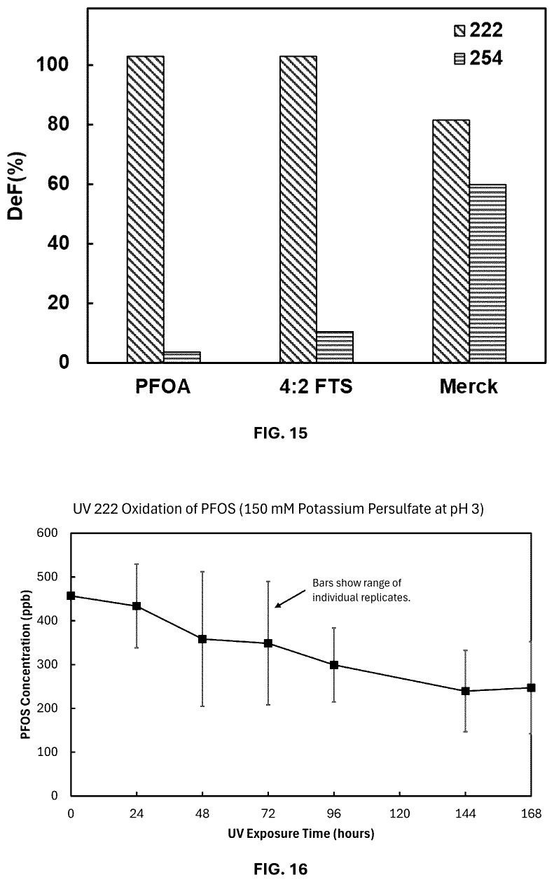

The results are presented in FIG. 15. FIG. 15 shows a comparison of defluorination percentage (DeF %) between UV-based persulfate oxidation at UV222 and UV254 under the following reaction conditions: 10 μM PFOA with 0.5 mM S₂O₈²⁻ at optimized pH 2 for 24 h; 10 μM 4:2 FTS with 0.5 mM S₂O₈²⁻ at optimized pH 7 for 24 h, Merck wastewater with 75 mM S₂O₈²⁻ at optimized pH 5 for 2 h.

From FIG. 15, it can be seen that UV222 nm/persulfate oxidation was more effective than UV254 nm/persulfate oxidation for fully fluorinated carboxylates (e.g., PFOA), fluorotelomer (e.g., 4:2 FTS) and fluoropolymer (Merck Wastewater). In the UV222 nm/persulfate oxidation system, PFOA and 4:2 FTS reached ˜100% defluorination after 24 h. Merck Wastewater reached a DeF % of >80%, whereas the DeF % were 3.7%, 10.5%, and 61.8%, respectively, for PFOA, 4:2 FTS, and Merck Wastewater in UV254 nm/persulfate oxidation system.

### Example 8

In this example the photoreactor used includes two cylindrical lamps, a machined metal support used to support the lamps horizontally at some distance above a level surface, a photoreactor vessel, and a metal enclosure. The lamps used were krypton/chloride excimer lamps (F40-150 W from Guangdong Excimer Optoelectronics Technology Co. Ltd., Guangdong Province, China) emitting UV radiation at approximately 222 nm. Each lamp was powered by a 20 kilovolt power supply, and consumed 100 Watts of electrical power. The lamps were 54 mm in diameter and 460 mm in length. The lamps were statically held 100 mm parallel from each other (center-to-center) at a fixed distance of 57.2 mm (surface to cylinder center) from the horizontal floor of the metal container by a rigid machined aluminum clamp.

The reactor vessel used was a cylindrical quartz vial QP062, Aireka Scientific Co., Ltd, HK) measuring 40.1 mm in diameter. The total height of the reactor vessel was 114.6 mm, of which 100 mm of the total height is of consistent diameter, the remaining 14 mm tapered to form a threaded top cylinder 12 mm in diameter. The photoreactor was contained in a metal enclosure. A metal filing drawer was used as the metal enclosure.

100 mL samples were prepared with approximately 500 ppb of PFOS. Samples were then adjusted to pH 3 with 37% HCl and 150 mM K₂S₂O₈ was added. Two duplicate samples were prepared in this manner.

Each sample was transferred into separate reactor vessels and sealed with threaded plastic caps with silicon septa screwed to the tops of the vials. The vials were placed between the parallel lamps, enabling radiation to enter the vessel from both sides. Samples were irradiated at 222 nm for 7 days.

1 mL samples were collected from each vial by syringe every 24 hours and stored for LCMS quantification. The PFOS concentrations were measured with the EPA 1633 method on a triple quadrupole mass spectrometer (LCMS-8060, Shimadzu Corporation, USA). The LCMS results of the photooxidation of PFOS are presented in FIG. 16, where the x-axis is UV222 exposure time in hours and range bars indicate the concentration range of individual replicates.

FIG. 16 depicts the steadily decreasing concentration of PFOS with time. The degradation achieved is relatively slow, but quantitative analysis using Pearson correlation coefficients calculated between time points and measured PFOS concentration demonstrated strong negative correlations across independent replicates (r=−0.82 and −0.86), indicating a statistically robust declining trend that is reproducible and distinct from measurement variability. This example therefore demonstrates the effectiveness of UV photooxidation to degrade PFOS at extended timescales.

As used herein, the terms “substantially” or “generally” refer to the complete or near complete extent or degree of an action, characteristic, property, state, structure, item, or result. For example, an object that is “substantially” or “generally” enclosed would mean that the object is either completely enclosed or nearly completely enclosed. The exact allowable degree of deviation from absolute completeness may in some cases depend on the specific context. However, the nearness of completion will be so as to have generally the same overall result as if absolute and total completion were obtained. The use of “substantially” or “generally” is equally applicable when used in a negative connotation to refer to the complete or near complete lack of an action, characteristic, property, state, structure, item, or result. For example, an element, combination, embodiment, or composition that is “substantially free of” or “generally free of” an element may still actually contain such element as long as there is no significant effect thereof.

In the foregoing description various embodiments of the invention have been presented for the purpose of illustration and description. They are not intended to be exhaustive or to limit the invention to the precise form disclosed. Obvious modifications or variations are possible in light of the above teachings. The embodiments were chosen and described to provide illustrations of the principals of the invention and its practical application, and to enable one of ordinary skill in the art to utilize the invention in various embodiments and with various modifications as are suited to the particular use contemplated. All such modifications and variations are within the scope of the invention as determined by the appended claims when interpreted in accordance with the breadth they are fairly, legally, and equitably entitled.

What is claimed is:

1. A method of treating wastewater for PFAS reduction comprising;
a. mixing wastewater including PFAS with an oxidizing species to form a treatment solution;
b. exposing the treatment solution to UV light from a UV light source at 222 nm for an adequate time and at a sufficient intensity to destroy the PFAS.

2. The method of claim 1 wherein step 1 further comprises mixing the wastewater with an acid or a base prior to step b.

3. The method of claim 1 wherein step 1 further comprises mixing the wastewater with an acid prior to step b.

4. The method of claim 1 wherein step 1 further comprises mixing the wastewater with a base prior to step b.

5. The method of claim 1 wherein the oxidizing species comprises persulfate ion.

6. The method of claim 1 wherein the UV light source comprises an excimer lamp.

7. The method of claim 6 wherein the UV light source comprises a krypton/chloride excimer lamp.

8. The method of claim 1 where the treatment solution prior to step b has a pH between 9 and 13.

9. The method of claim 1 wherein the wastewater includes essentially only one PFAS substance.

10. The method of claim 1 wherein the wastewater comprises a polymeric PFAS.

11. The method of claim 1 wherein the PFAS comprises a perfluoroalkyl carboxylate.

12. The method of claim 1 wherein the PFAS comprises a partially fluorinated perfluoroalkyl carboxylate.

13. The method of claim 1 wherein the PFAS comprises a perfluoroalkyl alkoxide or a perfluoroalkyl alcohol.

14. The method of claim 1 the wastewater comprises wastewater produced during semiconductor manufacturing.

15. A method of treating wastewater comprising:
a. mixing wastewater including compounds containing either a trifluoromethyl group or a difluoromethylene group with an oxidizing species to form a treatment solution;
b. exposing the treatment solution to UV light at 222 nm for an adequate time and at a sufficient intensity to destroy the compounds.

16. A method of continuously treating wastewater comprising:
a. mixing wastewater including PFAS with an oxidizing species to form a treatment solution;
b. exposing the treatment solution to UV light at 222 nm for an adequate time and at a sufficient intensity to destroy the PFAS while continuously flowing the treatment solution through a reactor from an inlet to an outlet.

17. The method of claim 16 wherein step 1 further comprises mixing the wastewater with an acid or a base prior to step b.

18. The method of claim 16 wherein step 1 further comprises mixing the wastewater with an acid prior to step b.

19. The method of claim 16 wherein step 1 further comprises mixing the wastewater with a base prior to step b.

20. The method of claim 16 wherein the oxidizing species is persulfate ion.
